(19) United States
(12) Patent Application Publication
(10) Pub. No.: US 2011/0066719 A1
(43) Pub. Date: Mar. 17, 2011

(54) Automated Applicatin Dependency Mapping

(76) Inventors: Vitaly Miryanov, Surrey (GB); Christian Roue, Paris (FR); Arvind Ramaswamy, Ottawa (CA)

(21) Appl. No.: 12/864,834

(22) PCT Filed: Jan. 31, 2008
(86) PCT No.: PCT/US08/52602

§ 371 Date: Nov. 30, 2010

(51) Int. Cl. G06F 15/173

(52) U.S. Cl. 709/224

(57) ABSTRACT

A computer-executed method for network management automatically maps applications to network infrastructure. The method comprises monitoring network activity on one or more managed computers and collecting network activity data on the managed computers. The association of executable files to applications is identified and network activity data and the association of executable files to applications are analyzed. Connections from applications on the managed computers are established according to the analysis.

### BACKGROUND

The field of Application Dependency Mapping (ADM) is not yet mature and designers are actively developing the discipline. A common approach involves modeling each application and parsing configuration data to identify other IT elements upon which the applications depend. The process is very time consuming and entails much customization for each supported application. Due to the complexity of producing application models, the number of applications that are recognized by the conventional ADM systems is not very high.

### SUMMARY

An embodiment of a computer-executed method for network management automatically maps applications to network infrastructure. The method comprises monitoring network activity on one or more managed computers and collecting network activity data on the managed computers. The association of executable files to applications is identified and network activity data and the association of executable files to applications are analyzed. Connections from applications on the managed computers are established according to the analysis.

### BRIEF DESCRIPTION OF THE DRAWINGS

Embodiments of the invention relating to both structure and method of operation may best be understood by referring to the following description and accompanying drawings:

FIG. 1 is a schematic block diagram illustrating an embodiment of a network system that includes application dependency mapping functionality;

FIG. 2 is a schematic block diagram depicting an embodiment of a network system for collection of network connection information for usage in ADM; and

FIGS. 3A through 3E are flow charts showing one or more embodiments or aspects of a computer-executed method for network management that automatically maps applications to network infrastructure.

### DETAILED DESCRIPTION

Embodiments of a network system and associated operating techniques are described for determining software application relationships using network connections in combination with the detailed software application inventory information made available by the discovery system.

Application Dependency Mapping (ADM) is a technique for tracking dynamically changing computing environments by monitoring how applications and their underlying components interact with one another. The monitored data facilitates analysis of the impact that a change in one application or application component will have, prediction of consequences of slowing or stopping of an application, and determination of procedures to resolve the problem. ADM is useful in a Configuration Management Database (CMDB) to enable identification and creation of a visual map of devices that support an application including servers, routers and switches. ADM also enables monitoring and analysis of software components and code dependencies relied upon by an application, as well as network configurations such as routing tables and port assignments that allow applications to travel across an enterprise. In an example implementation, ADM enables an organization to dynamically allocate resources and improve server utilization based on business need to better use overall data center resources.

Application Dependency Mapping (ADM) is a technique for discovering installed software applications and resolving application interdependence and dependence with respect to Information Technology (IT) infrastructure. Application dependency information can have many uses, for example in the milieu of Enterprise Systems Management. Uses can include populating a Configuration Management Database (CMDB) with relationship information, service and change management, and data center management.

Thus an improved, automatic approach is sought to ease the implementation and improve application coverage of Application Dependency Mapping.

One ADM approach involves maintaining a comprehensive model of configuration data for each supported application. To collect data for such a model, various up-to-date credentials for logging into the system and/or the application are used. A discovery system connects to the computer which hosts the application remotely and runs various scripts and detection logic to identify the application version and the detailed configuration of the version. Overhead of the ADM approach includes operations of collecting the credentials and maintaining a current list since many security policies enforce the change of passwords on a regular basis. Maintaining such models can be time consuming since the configuration of applications can change from one version to another. Maintaining the models is usually suitable for large and complex applications, such as Applications and Database Servers (ADS) in which additional discovery information detected during the time consuming deep discovery can be useful.

Another ADM technique captures and interprets network packets passing through the network and, based on the content of the packets, resolves which applications are sending and receiving the packets. The discovery application or appliance has to be connected to a switch that passes through all network traffic, a connection that is not always possible. Increasingly encrypted communications are used to secure communications between applications, even on the local area network, which prevents investigation of the actual content of network packets and derivation of application dependency from the actual content.

In an illustrative embodiment of an Application Dependency Mapping (ADM) technique, dependencies between applications are determined by discovering the actual network communications between the applications. In some embodiments and/or in some conditions, since the majority of network communications today is done using the TCP/IP network protocol, the network discovery can monitor the TCP/IP network activity on each managed computer. In other embodiments or operative in other conditions, the technique can be applied to other network protocols. The technique can be implemented using an agent that runs continuously on all managed computers, collecting information including Start/End timestamps of a connection, Local and Remote host and port information, the absolute path to the executable file that established the connection, and the like.

The collected network connection information can be stored on each managed computer for a specific period of time, for example one month. The collected network activity data is combined with the software inventory information. The software inventory can be used to identify installed applications using a file-based software recognition process. The recognition process uses a Software Application library, a knowledge base that captures details of files that comprise various applications, including file name, size, signature, and executable type. For example, an executable in question can be msaccess.exe, which is deduced to be a part of Microsoft Access based on the information stored in the Software Application Library. However, a file or files with the same name, signature and size can be part of many different applications, so the recognition process employs a sophisticated algorithm that takes into account other files located in the same directory as well as elsewhere on the computer, allowing accurate recognition to take place. The recognition process identifies which executable files belong to which application. Once the information is collected for all managed computers, a topology determination process can be invoked that analyzes network connectivity on all computers and uses the timestamps and host information to establish the connection from an application on one computer with the application on another computer, thus obtaining the correct Application Dependency Mapping data.

Software inventory is more mature discipline than application dependency mapping and thus has higher application coverage. The illustrative new technique exploits availability of existing and mature software application inventory data and can enhance application relationship information.

The illustrative technique can be implemented without development of complex application models and uses mature file-based application recognition technology that is simple to maintain. As a result, the technique enables much higher application coverage than other methods and functions well even in cases of encrypted network communications.

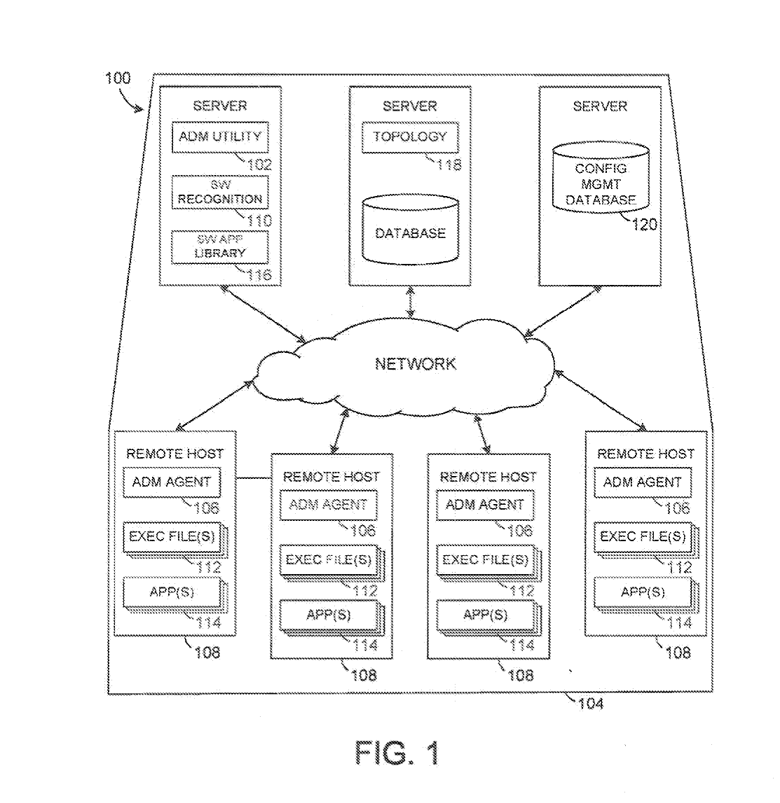

Referring to FIG. 1, a schematic block diagram illustrates an embodiment of a network system 100 that includes application dependency mapping functionality. The illustrate network system 100 comprises a utility 102 that automatically maps applications to network infrastructure 104. The utility 102 comprises at least one instance of an agent 106 that monitors network activity on a remote host computer 108 and collects network activity data on the remote host computer 108 as a managed computer. The utility 102 further comprises a file-based software recognition process 110 that is communicatively coupled to the agent instances 106 and identifies the association of executable files 112 to applications 114, analyzes the network activity data and the association of executable files 112 to applications 114, and establishes connections from applications 114 on the managed computers 108 according to the analysis.

In an example embodiment of an agent 106, file information can be sourced by a component called a scanner that collects the inventory. Software inventory includes detailed file information, for example that can be used in recognition such as file name, size, other attributes, and the like. The agents 106 can be configured to operate by continuously or periodically collecting the network activity data, for example start and end timestamps of a connection, local and remote host and port information, identification of an absolute path to an executable file that establishes a connection, and the like. In some embodiments, the agents 106 can collect the data continuously or can be selectively activated and deactivated to collect information in a non-continuous manner such as periodically or intermittently. For example, when a user, customer, system manager, or the like does not want to install an agent permanently on a computer, the utility can be configured so that the agent runs periodically.

The agent instances 106 can be configured to collect network activity data on the managed computer 108 using a predetermined collection, protocol, for example Transmission Control Protocol/Internet Protocol (TCP/IP) or any other suitable network protocol. The agent instances 106 also monitor network protocol activity on the managed computers 108.

The agents 106 instance can operate by discovering network communications between network applications 114 and operating in combination with the software recognition process 110, which determines application dependencies based on the discovered network communications.

In some embodiments, the network system 100 can further comprise a software application library 116 for usage by the software recognition process 110. The library 116 compiles data of executable files 112 associated with applications 114 including file name, file size, file signature, file version data, file executable type, and selected file attributes. The software recognition process 110 identifies association of executable files 112 to applications 114.

In some embodiments, the network system 100 can further comprise multiple agents 106 that collect network activity data for all managed computers 108 which operate in combination with a topology determination process 118 that analyzes the network activity data and the association of executable files 112 to applications 114 on all managed computers 108. The software recognition process 110 establishes connections among applications 114 using timestamps and host information.

The network system 100 can further comprise a configuration is management database 120 which can communicate and operate in combination with the software recognition process 110 and receives relationship information of executable files 112 to applications 114. For example, software recognition 110 can accumulate or develop a list of applications installed on the computer. A utility that calculates application topology stores the application dependency information into a local database. The application dependency information can be used to populate the configuration management database 120.

The illustrative network system 100 performs a universal method of automatic application dependency discovery that is not constrained to the development of complex application models. The illustrative utility 102 can combine existing file-based application recognition technology and network topology information, for example within the OpenView Enterprise Discovery system from Hewlett Packard Company (HP) of Palo Alto, Calif., with information of active network connections on a host and the processes associated with the connections to determine interdependencies between applications and the IT infrastructure.

In contrast to basing the discovery system on complex models such as scripts and the like, and also relying on the user intervention and/or adjustment, the illustrative network system 100 can be fully automated and can recognize particular applications and associated dependencies without use of complex models and/or scripts. The network system 100 is also robust and adapts to changes in application behavior, even if the behavior evolves over time, changes rapidly, or otherwise has a dynamic character.

The technique performed by the network system 100 is non-intrusive and, although using installation of an agent 106 for ADM functionality, does not require port scans, capturing and monitoring of the network traffic, and the like. Network connection and/or process information is “passively” observed. In some implementations, the incremental load on the system imposed by ADM functionality can be reduced by combined ADM functionality with a software utilization agent that is used for other functionality.

The network system 100 and utility 102 can operate continuously, based on historical data, and does not miss occasional dependencies and/or applications that run infrequently. The network system 100 and utility 102 are highly accurate and can use a software library to recognize processes, and are adaptable to changes without amending the complex scripts and/or models.

Application Dependency Mapping (ADM) is considered by many in the IT industry as an insufficiently developed component affecting Business Service Management (BSM), Configuration Management Database (CMDB), and Information Technology Service Management (ITSM) strategies. ADM technology is viewed as strategic piece of most current IT implementations, and has grown in importance with the heightened interest in data center consolidation projects. Market adoption of initial ADM implementations has been slow, at least partly due to the complexity of producing application models, so that the number of applications that are recognized by the current ADM vendors is not very high—up to a few hundred applications. In contrast, HP so OpenView Enterprise Discovery can identify about 20,000 different application versions using an associated software inventory capability. In an illustrative embodiment, the network system 100 and utility 102 enable an improved automatic approach for facilitating implementation and improving application coverage of ADM by leveraging the existing OpenView software inventory capability.

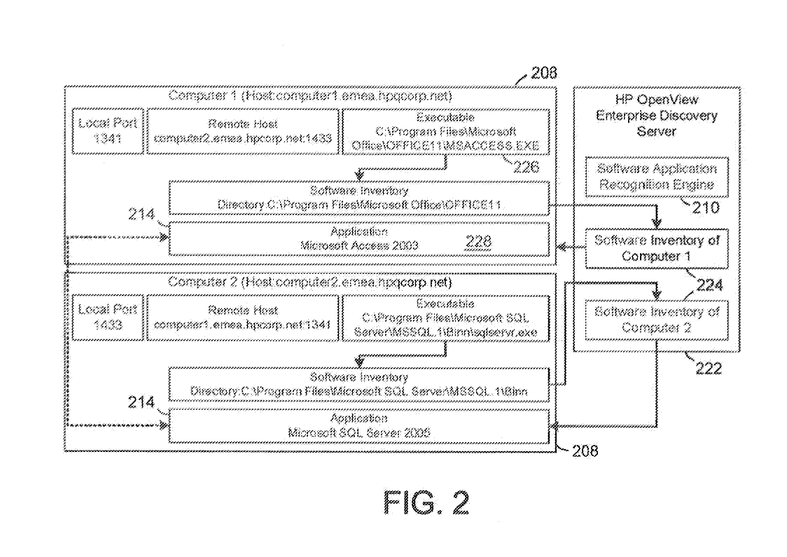

Referring to FIG. 2, a schematic block diagram depicts an embodiment of a network system 100 for collection of network connection information for usage in ADM. Collected network connection information can be stored on a plurality of managed computers 208 for a specific period of time, for example one month. The information can be combined with the software inventory information and passed over to the HP OpenView Enterprise Discovery Server 222 for further processing. The server 222 uses the software inventory 224 to identify installed applications 214 using an existing file-based software recognition process 210. The recognition process 210 uses a Software Application library, a knowledge base that captures details of files that make up various applications 214, including file name, size, signature, and executable type. For example, an executable under consideration such as msaccess.exe 226 is deduced to be a part of Microsoft Access 228 based on information stored in the Software Application Library. However, a file or files with the same name, signature and size can be part of many different applications, so the recognition process 210 employs a sophisticated algorithm taking into account other files located in the same directory as well as elsewhere on the computer 208, enabling accurate recognition, including determining whether a particular application is installed standalone or as part of a suite, for example whether Microsoft Access is standalone or is installed as part of Microsoft Office. Once the raw network connection is enriched with the application information, the network connection data is stored in the database. A separate topology determination process on the Enterprise Discovery server 222 can be executed once a day to process information for each managed computer 208 and, using the timestamps and host information, establishes the connection from an application on one computer with the application on another one, thus obtaining the ADM data.

FIG. 2 illustrates how msaccess.exe on a Computer 1 opens a connection to sqlservr.exe on computer 2. Once recognized that msaccess.exe is in fact Microsoft Access 2003 and sqlservr.exe is Microsoft SQL Server 2005, a dependency mapping between the two applications can be made.

The file-based application recognition technology 210 that can be used in the ADM technique can be a process operative within the HP OpenView Enterprise Discovery product. The Enterprise Discovery product also implements agent technology that detects software application utilization by monitoring the running processes and associates the data to the associated applications. The illustrative ADM system and operating method extends the discovery technology further to collect network activity data, and adds a new server module to process the connectivity information and determine application dependencies.

Network activity data can be obtained by existing system tools, such as netstat and Isof. Netstat (network statistics) is a command-line tool available in Unix, Unix-like, and Windows NT based operating systems that displays network connections including both incoming and outgoing connections, routing tables, and various other network interface statistics. Lsof is a command to list open files which is used in Unix and Unix-like systems to report a list of all open files and the processes that opened the files. The netstat command can be extended beyond typical functionality, for example by adding code that runs in kernel mode, to obtain the full executable file name and process information for the application that establishes TCP connections on operating systems such as Windows NT and Windows 2000.

The illustrative ADM system and operating method can exploit the file-based application recognition technology within the OpenView Enterprise Discovery to generate a view of the actual dependencies without building complex models of applications, and hence is more widely applicable to applications. Functionality of the disclosed ADM system and technique are complementary to configuration-based modeling techniques that give an expected view of dependencies.

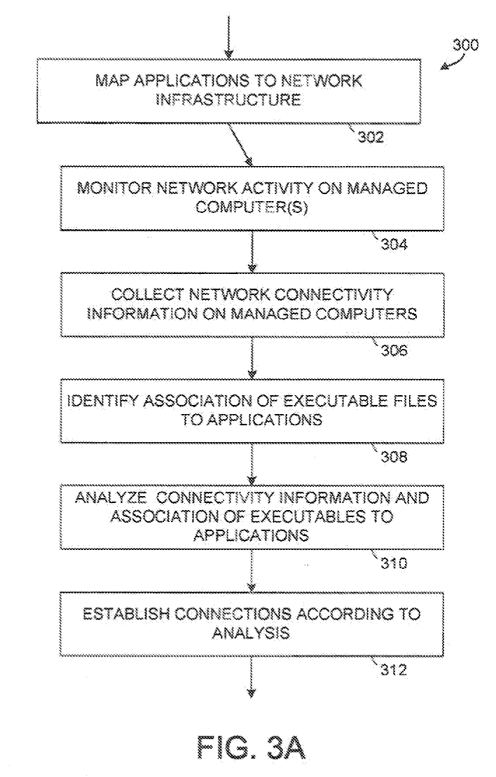

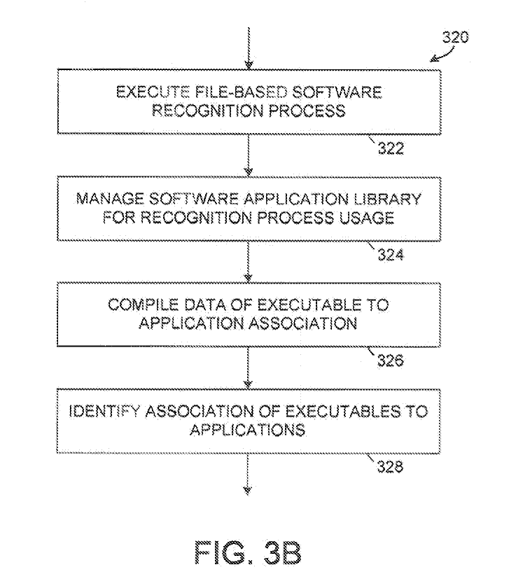

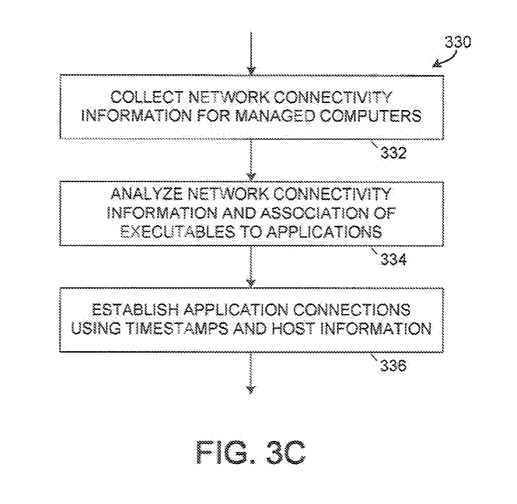

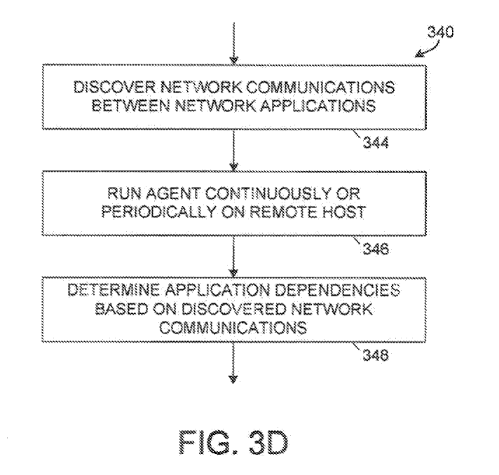

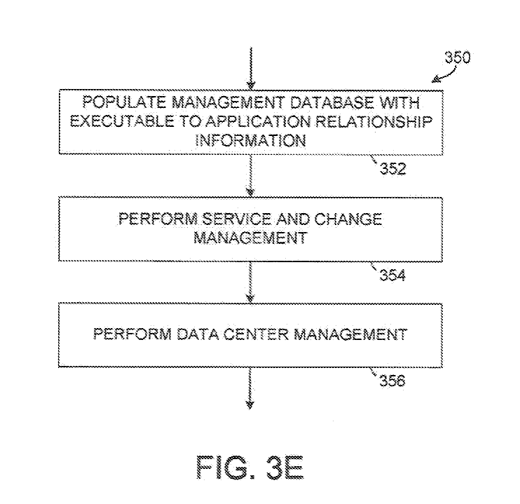

Referring to FIGS. 3A through 3E, flow charts illustrate one or more embodiments or aspects of a computer-executed method 300 for network management that automatically maps 302 applications to network infrastructure. The method 300 comprises monitoring 304 network activity on one or more managed computers and collecting 306 network activity data on the managed computers. The association of executable files to applications is identified 308 and network activity data and the association of executable files to applications are analyzed 310. Connections from applications on the managed computers are established 312 according to the analysis.

In an example implementation, the network activity can be monitored 304 by agents installed on the managed computers. Analysis 310 of executable files to applications can exploit network discovery and inventory tools in existence in the network.

In an illustrative embodiment, the action of collecting 306 network activity data can comprise collecting start and end timestamps of a connection, local and remote host and port information, identification of an absolute path to an executable file that establishes a connection, and other suitable information.

The network activity data can be collected 306 on the one or more managed computers using a predetermined collection protocol. The connectivity information can be collected for a predetermined time period. For example, rather than collecting the information for a limited time period and then stopping, a more suitable protocol may collect the information for a sliding time window. In a specific example, historical network data can be collected for, for example, the most recent two-week period or for the last month. In another example protocol, information can be collected periodically. Network connectivity data can be feasibly collected for a few hours per day with historical data maintained for a sliding window of on the order of weeks of time.

Referring to FIG. 3B, a flow chart depicts an illustrative method for automatically mapping 320 applications to network infrastructure. The method 320 comprises executing 322 a file-based software recognition process, and managing 324 a software application library for usage by the software recognition process. Library management can comprise compiling 326 data of executable files associated with applications including file name, file size, file signature, file version data, file executable type, and selected file attributes. The association of executable files to applications is identified 328 according to the software recognition process.

In the illustrative method 320, the software application library is used to resolve and identify applications to which a particular process belongs. Because a process with a particular name can belong to several applications or to multiple versions of the same application, the combination of the inventory of the computer with the application recognition based on the application library that reliably identifies the exact application in use is effective.

Referring to FIG. 3C, an embodiment of an application mapping method 330 can comprise collecting 332 network activity data for all managed computers, and analyzing 334 the network activity data and the association of executable files to applications on all managed computers using a topology determination process. Connections among applications can be established 336 using timestamps and host information.

Referring to FIG. 3D, a flow chart illustrates another embodiment of a method that can be used for automatic application mapping 340. The method 340 comprises discovering 344 network communications between network applications, and determining 348 application dependencies based on the discovered network communications.

In some implementations, the network communications can be discovered 344 by monitoring network protocol activity on the managed computers. For example, an agent can be run 346 continuously or periodically on a remote host that monitors network protocol activity. For example, Transmission Control Protocol/Internet Protocol (TCP/IP) or any other suitable network protocol can be monitored to enable determination of application dependencies on infrastructure.

In an example implementation or under selected conditions, the collection of the network connection information along with other data, such as processes associated with the data is continuous, in contrast to a one-time snapshot that determines how infrastructure is connected at any particular moment in time when the discovery process is running. The illustrative technique 340 enables constant monitoring of network connections and maintenance of historic connection/process data from all managed computers, enabling detection of application dependencies for those connections that are established infrequently/for short duration periods.

Referring to FIG. 3E, a flow chart illustrates an embodiment of an example method 350 for using the information resulting from automatic application mapping. The illustrative method 350 comprises populating 352 a configuration management database with relationship information of executable files to applications and performing selected management operations. In some embodiments, the method can comprise performing 354 service and change management. Some techniques can include performing 356 data center management.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A computer-executed method for network management comprising:
automatically mapping applications to network infrastructure comprising:
monitoring network activity on at least one managed computer;
collecting network activity data on the at least one managed computer;
identifying association of executable files to applications;
analyzing the network activity data and the association of executable files to applications; and
establishing connections from applications on the at least one managed computer according to the analysis.

2. The method according to claim 1 further comprising:
collecting the network activity data comprising start and end timestamps of a connection, local and remote host and port information, and identification of an absolute path to an executable file that establishes a connection.

3. The method according to claim 1 further comprising:
collecting network activity data on the at least one managed computer using a predetermined collection protocol.

4. The method according to claim 1 further comprising:
executing a file-based software recognition process;
managing a software application library for usage by the software recognition process comprising compiling data of executable files associated with applications including file name, file size, file signature, file version data, file executable type, and selected file attributes; and
identifying association of executable files to applications according to the software recognition process.

5. The method according to claim 1 further comprising:
collecting network activity data for all managed computers;
analyzing the network activity data and the association of executable files to applications on all managed computers using a topology determination process; and
establishing connections among applications using timestamps and host information.

6. The method according to claim 1 further comprising:
discovering network communications between network applications; and
determining application dependencies based on the discovered network communications.

7. The method according to claim 1 further comprising:
monitoring network protocol activity on the managed computers; and
continuously or periodically running an agent on a remote host that monitors network protocol activity.

8. The method according to claim 1 further comprising:
populating a configuration management database with relationship information of executable files to applications;
performing service and change management; and
performing data center management.

9. A network system comprising:
a utility that automatically maps applications to network infrastructure comprising:
at least one instance of an agent that monitors network activity on a remote host computer and collects network activity data on the remote host computer as a managed computer, and
a file-based software recognition process communicatively coupled to the at least one agent instance that identifies association of executable files to applications, analyzes the network activity data and the association of executable files to applications, and establishes connections from applications on the managed computers according to the analysis.

10. The system according to claim 9 further comprising:
the at least one agent instance that continuously or periodically collects the network activity data comprising start and end timestamps of a connection, local and remote host and port information, and identification of an absolute path to an executable file that establishes a connection.

11. The system according to claim 9 further comprising:
the at least one agent instance that collects network activity data on the managed computer using a predetermined collection protocol.

12. The system according to claim 9 further comprising:
the at least one agent instance that monitors network protocol activity on the managed computers.

13. The system according to claim 9 further comprising:
a software application library for usage by the software recognition process that compiles data of executable files associated with applications including file name, file size, file signature, file version data, file executable type, and selected file attributes; and
the software recognition process that identifies association of executable files to applications.

14. The system according to claim 9 further comprising:
a plurality of agents that collect network activity data for all managed computers; and
a topology determination process that analyzes the network activity data and the association of executable files to applications on all managed computers; and
the software recognition process that establishes connections among applications using timestamps and host information.

15. The system according to claim 9 further comprising:
the at least one agent instance that discovers network communications between network applications; and
the software recognition process that determines application dependencies based on the discovered network communications.

16. The system according to claim 9 further comprising:
a configuration management database communicatively coupled to the software recognition processor for receiving relationship information of executable files to applications.

17. An article of manufacture comprising:
a controller-usable medium having a computer readable program code embodied therein for automatically mapping applications to network infrastructure, the computer readable program code further comprising:
code causing the controller to monitor network activity on a plurality of remote host computers and collect network activity data on the remote host computers as managed computers;
code causing the controller to identify association of executable files to applications;
code adapted to cause the controller to analyze the network activity data and the association of executable files to applications; and
code adapted to cause the controller to establish connections from applications on the managed computers according to the analysis.

18. The article of manufacture according to claim 17 further comprising:
code causing the controller to continuously or periodically collect the network activity data using a predetermined collection protocol comprising start and end timestamps of a connection, local and remote host and port information, and identification of an absolute path to an executable file that establishes a connection.

19. The article of manufacture according to claim 17 further comprising:
code causing the controller to execute a file-based software recognition process;
code adapted to cause the controller to manage a software application library for usage by the software recognition process comprising compiling data of executable files associated with applications including file name, file size, file signature, file version data, file executable type, and selected file attributes; and
code adapted to cause the controller to identify association of executable files to applications according to the software recognition process.

20. The article of manufacture according to claim 17 further comprising:
code causing the controller to collect network activity data for all managed computers;
code adapted to cause the controller to analyze the network activity data and the association of executable files to applications on all managed computers using a topology determination process; and
code adapted to cause the controller to establish connections among applications using timestamps and host information.
